(19) United States
(12) Patent Application Publication
(10) Pub. No.: US 2002/0046352 A1
(43) Pub. Date: Apr. 18, 2002

(54) Method of authorization by proxy within a computer network

(76) Inventor: George Stone Ludwig, San Francisco, CA (US)

Correspondence Address: PATRICK REILLY, BOX 7218, SANTA CRUZ, CA, 95061-7218, US

(21) Appl. No.: 09/970,063

(22) Filed: Oct. 3, 2001

Related U.S. Application Data
(60) Provisional application No. 60/237,995, filed on Oct. 5, 2000.

(51) Int. Cl. G06F 11/30

(52) U.S. Cl. 713/201

(57) ABSTRACT

A method for enabling participants in an information technology (IT) system or a computer network to delegate user authority to other system participants is provided. The method of the present invention includes the generation of a proxy authorization. The proxy authorization, or proxy, is used by the IT system to insure that a given participant may have access to resources on the basis of a permission granted and intended by another user or agent of the IT system, and that the grantor of the permission is authorized to issue the access and/authorities as designated by or within the proxy authorization. A medical record repository, for example may allow unlimited access to particular individual patient records to an individual medical doctor. The doctor can then authorize a specific pharmacy to have limited access to designated portions of the medical records of certain of the patients to whom the doctor is authorized access. The pharmacy may then allow access to distinct and different subsets of the portions of the records, to which the pharmacy is authorized access to by a proxy issued by the doctor, to an insurance company, to a billing clerk, and to pharmacists. The use of proxies thereby allows for efficient B2B collaborative message processing using languages such as XML.

### CONTINUATION-IN-PART

This application is a Continuation-in-Part to Provisional Patent Application No. 60/237,995, filed on Oct. 5, 2000. This application claims benefit of the filing and priority date of Oct. 5, 2000 of Provisional Patent Application No. 60/237995.

### FIELD OF THE INVENTION

The present invention relates methods of allocating authorization of access to resources within a computer network. More particularly, the present invention addresses the needs of participants in processes managed via computer networks to selectively allocate access to resources to specified parties.

### BACKGROUND OF THE INVENTION

The importance in the use of computer networks, such as the Internet, intranets and extranets, to the manufacturing, financial, transportation, medical, military, governmental, consulting and service industry sectors has greatly increased in the last several years. This trend is continuing to expand the significance of a long felt need for a method to allow participants in information technology processes to delegate authority over, and/or access to, resources available over a computer network to specified parties on limited and unlimited bases.

In the shipping industry for example, a manufacturing firm may generate a shipping document for use in initiating a shipment and in tracking the progress and status of the shipped goods. This shipping document might be created as an electronic document and sent via a computer network to the shipping agent. The shipping agent might then maintain the shipping document as a living record that is consistently updated with status information concerning the shipped goods. The shipping agent might also authorize the shipper to have access to the shipping document for purposes of viewing or editing the shipping document. The shipper may wish to share the authorization to access the shipping document to the intended recipient of the shipped goods. The shipper may wish to authorize access to view and/or edit the shipping document to the recipient on a limited basis, e.g. access to view only, or on a basis equal to the range of authority and access as issued by the shipping agent to the shipper, e.g., to both view and edit.

The prior art includes techniques for authentication of messages that create access to electronic documents by more than one party. The management of medical or financial records, as two commercially extensive examples, evidences many situations where access to electronic documents by numerous participants may be desirable, and where such access may be issued by various authorities, or grantors, such as a patient, an attending physician, an insurance agent, a regulatory agency. And the access to be delegated may need to be based upon the authority as previously granted to the issuing authority. The issuing authority may wish to constrain the access issued to an identified grantee with numerous potential parameters, such as time period, access level, type of data, etc.

There exists in many industries and arts a long felt need for methods and techniques that support efficient management of automated business-to-business messaging that would be well addressed by a flexible method of delegating, by one party to another, control of access and authorization of resources available over a computer network

### OBJECTS OF THE INVENTION

It is an object of the present invention to provide a technique that enables a grantor to delegate access to a resource to a grantee via a computer network. It is a further object of the present invention to provide a method to optionally delegate authority over a resource to a grantee, where the authority is optionally possessed by the grantor.

### SUMMARY OF THE INVENTION

These and other objects and advantages of the present invention are achieved by the method of the present invention wherein a grantor, a grantee, and a resource repository, acting via a computer network, enable the grantee to have access to a resource associated with the resource repository. The resource may be a system, process or function, such as an electronic database record, a software file, or an access protocol to an electronic hardware, that is controlled, monitored or bi-directionally related to a computer or a computer network,

The method of the present invention enables the grantor to authorize the grantee to have access to, or authority over, a resource by issuing, or causing to have issued, a proxy authorization, whereby the communication of the proxy authorization is transmitted within the computer network to cause the resource repository to enable, permit, or not inhibit, the grantee from exercising the access to, or authority over, the resource within a range of access or authority intended by the grantor, and where the grantor is authorized to issue the range of access and/or authority at least equal to the range that the grantor intended to issue to the grantee.

According to certain preferred embodiments of the method of the present invention, the grantor possesses an identify that may be authenticated by the resource repository and/or the grantee, and permission to access the resource; the grantee possesses an identify that may be authenticated by the resource repository and/or the grantor; and the resource repository is capable of authenticating the grantor and grantee identities, and the resource repository has the authority to deny or permit access to the resource. The grantor may send a message to the resources repository, or repository, that informs the repository that the grantee has an authority to access, control, monitor, interact, modify and/or edit the resource equal. The grantee may receive access to or authority over the resource that is different from or identical to the grantor's access to or authority over the resource,

In certain alternate preferred embodiments of the method of the present invention, the grantor may further possess an electronic credential, or e-credential, that informs the resource repository of the grantors access rights and authority or authorities over the resource. The e-credential may be verifiable and the repository may have the ability to authenticate and/or verify the e-credential. The repository may include an e-credential verifier that insures that an authority or an access requested by the grantor or grantee has been authorized by the terms contained within, or terms referenced by, the e-credential. The repository may further comprise a proxy reader that determines from the proxy authorization the authorities and access privileges extended to the grantee by the grantor.

In certain still alternate embodiments of the method of the present invention, the grantor may issue access rights or authorities to grantees that exceed the access rights to and/or authorities over the resource of the grantor itself.

In a preferred embodiment of the method of the present invention, the grantor issues the proxy authorization. The proxy authorization comprises the e-credential in total or in part, an identifier associated with the grantee, an identifier associated with the resource, and an identifier associated with the grantor. The proxy authorization may also include a limitation of the range of access and/or authorization as stipulated within or referred to by the e-credential, where the limitation restricts the access and/or authority to be less than the access and/or authority as indicated by the e-credential. This limitation of range of access and/or authority is referred to herein as the scope of grant. The scope of grant may optionally extend in certain applications of the method of the present invention to a range fully equal to the range indicated by the e-credential, or by another functional aspect of an IT system or structure. The scope of grant may be limited to the access and authorities permitted to the grantor to itself.

The grantee is enabled by the use of the proxy authorization to issue a request to the repository that the repository will permit, enable or not inhibit, such that the grantee may access the resource within a range of permission authorized by the proxy authorization. In a preferred embodiment, the grantee forms a message that bundles the proxy with the request. The grantee transmits the message to the repository. The repository then reads the message, identifies the grantor and the grantee, and determines if the e-credential and the scope of grant authorize the request to be processed. If the request is authorized by the e-credential and the scope of grant, and the repository can then successfully authenticate the sender of the request as being the true grantee of the relevant proxy. The repository will then enable, allow or fail to inhibit the processing of the request.

In another alternate preferred embodiment of the method of the present invention, the grantor issues the proxy authorization to a proxy registry. The proxy registry, or registry, maintains the proxy authorization. The grantee thereafter transmits a request to the registry, where the request is intended to be processed by the repository. The registry then determines if the proxy authorization, or another proxy registration accessible within or by the registry, indicates that the grantee is authorized to cause the resource to process the request. If the registry locates a proxy authorization that authorizes the request issued by the grantee, the registry then bundles the relevant proxy authorization, in whole or in part, with the request and transmits the bundled message to the grantee. The grantee then forwards the bundled message to the repository. The repository then authenticates the forwarded message as being forwarded by the grantee and as having the request bundled with the proxy authorization by the registry. If these two authentications of the message sent from the grantee to the repository are successfully accomplished by the repository, the repository then enables, allows, or fails to inhibit access to the resource and the request is processed,

Certain still alternate preferred embodiments of the present invention, suitable encryption methods, validation methods, and/or authentication methods known in the art are incorporated by the method of the present invention to increase the security of the use of the proxy authorization over the Internet, a virtual private network, an extranet, an intranet, or another suitable computer network or network type known in the art.

In certain yet alternate preferred embodiments of the method of present invention, proxy permissions and authorizations may be overridden or denied, in specificity or totality, by means of a specific directive whereby a safety administration function is imposed on the proxy system. This safety administration function may be useful to inhibit particular usages, applications, practices and/or outcomes of the proxy permission system.

Certain preferred embodiments of the method of the present invention comprise the use of XML language software and/or XML messaging, or other suitable software techniques, software systems and software languages known in the art.

### BRIEF DESCRIPTION OF THE DRAWINGS

These, and further features of the invention, may be better understood with reference to the accompanying specification and drawings depicting the preferred embodiment, in which:

FIG. 1 depicts a computer network with four unique addresses.

FIG. 2 is a work process flowchart of the process flow of a First Preferred Embodiment.

FIG. 3 depicts a Proxy Authorization as incorporated into the First, Second and Third Preferred Embodiments of FIGS. 2, 6 and 7 respectively.

FIG. 3A illustrates a resource request message.

FIG. 4 illustrates a resource request authorization message as implemented in the First Preferred Embodiment of FIG. 2.

FIG. 5 illustrates a request with proxy message as implemented in the First Preferred Embodiment of FIG. 2.

FIG. 6 is a work process flowchart of the process flow of a Second Preferred Embodiment of the method of the present invention.

FIG. 7 is a work process flowchart of the process flow of a Third Preferred Embodiment of the method of the present invention.

FIGS 8A, 8B and 8C present abstracts of message format used in certain alternate preferred embodiments of the method of the present invention.

FIG. 9 depicts an abstracts of a message format used in certain still alternate preferred embodiments of the method of the present invention.

### DETAILED DESCRIPTIONS OF PREFERRED EMBODIMENTS

In describing the preferred embodiments, certain terminology will be utilized for the sake of clarity. Such terminology is intended to encompass the recited embodiment, as well as all technical equivalents which operate in a similar manner for a similar purpose to achieve a similar result.

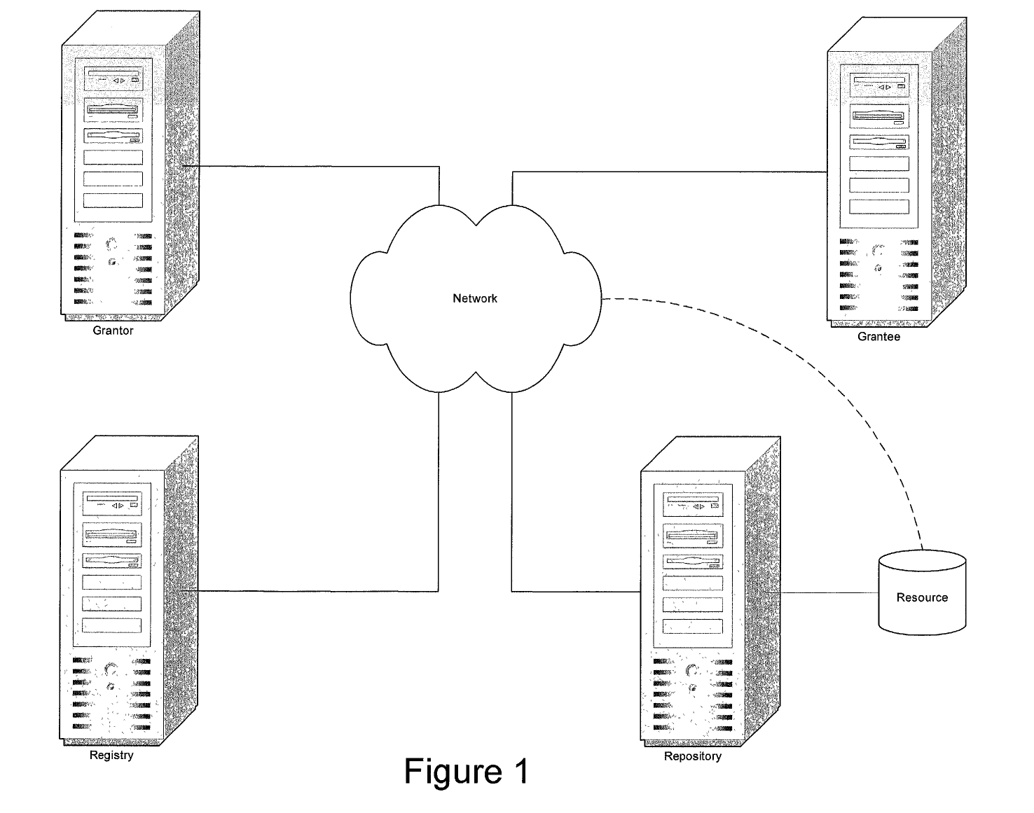

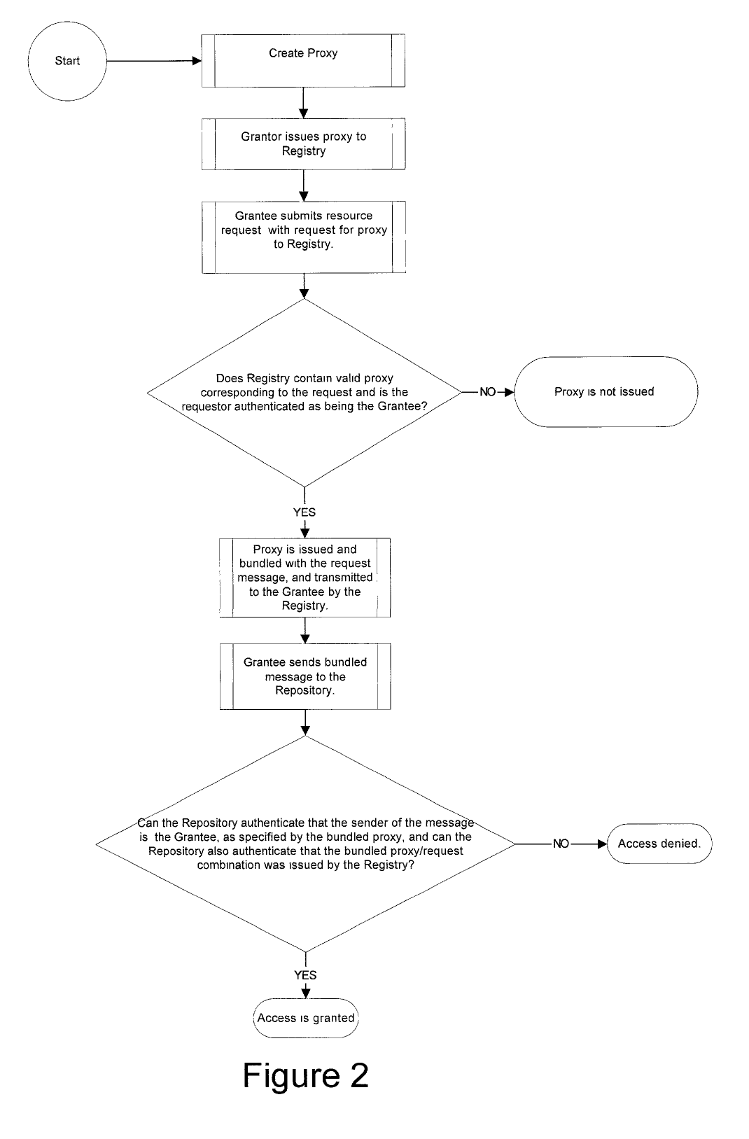

Referring now to the Figures and particularly to FIGS. 1 and 2, a set of four addresses, such as Internet Protocol addresses, or Uniform Resource Locator addresses, or another computer network addressing convention known in the art, are established within a computer communications network. The set of four identities shown in FIG. 1 consist of a Grantor, a Grantee, a resource Repository, and a Registry. All four identities are presented within the computer network and possess addresses. Each of these four addresses may be authenticated by each of the other three identities by using suitable authentication techniques known in the art. A resource is in communication with the repository and may optionally be in direct communication with the computer network. Alternatively, the resource may be accessible only via the resource repository by a suitable computer network or computer architectural design known in the art.

The resource repository, or repository, controls access to a resource. The grantor and the resource repository have an established workflow method, wherein the grantor is assigned an electronic credential by the resource repository. This electronic credential, or e-credential, explicitly or implicitly, informs the repository as to the exact permissions and terms under which the grantor is allowed to delegate access to or authority over the resource.

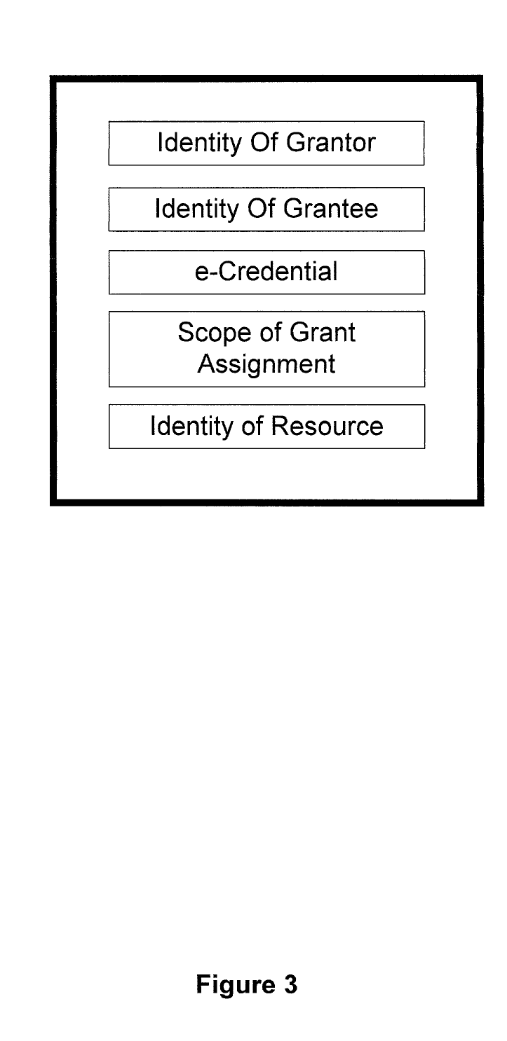

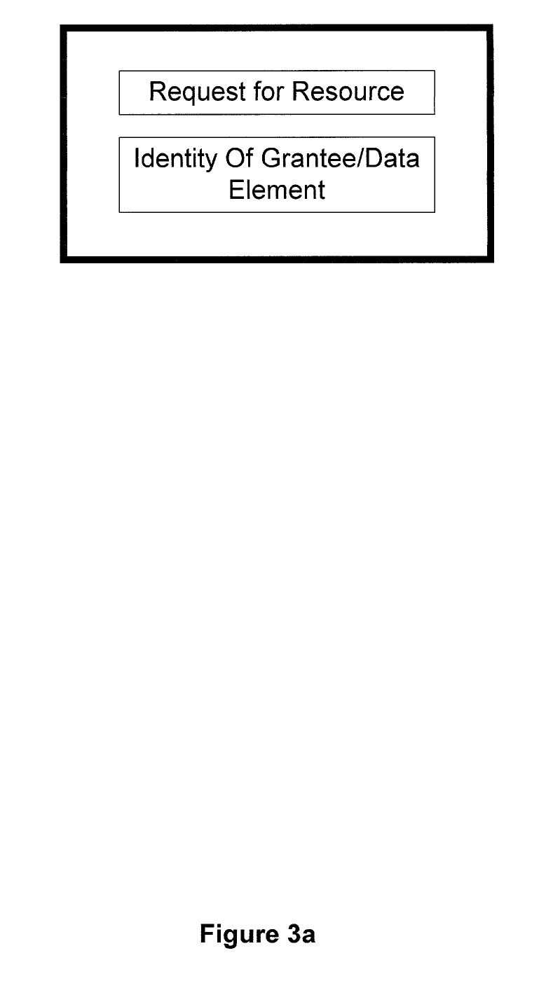

Referring now to the Figures, and particularly FIGS. 1, 2 and 3, consider that the grantor wishes to allow the grantee to have some access to the resource. In the method of the present invention, the grantor may, for this purpose, create a proxy authorization as illustrated in FIG. 3. The proxy authorization includes the identity of the grantor, the identity of the grantee, the e-credential or some reference to the e-credential, a scope of grant assignment, and the identity of the resource. The resource may either have an IP address and identity or may be managed by the repository by some alternate communications or architectural means. The scope of grant assignment defines what subset of access to the resource that is enabled by the e-credential to the grantor is to be conferred upon the grantee and recognized by the repository. The proxy may further revoke a previously issued scope of grant.

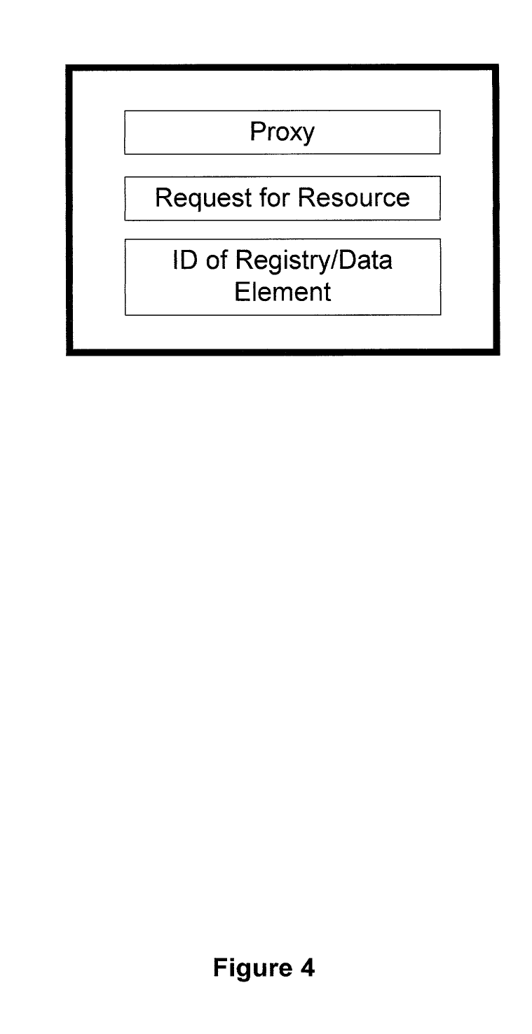

Referring now generally to the Figures and particularly to FIG. 2, the grantor creates the proxy authorization of FIG. 3 and issues the proxy authorization, or proxy, to the registry. The grantee next desires to have access to the resource, and submits a resource request message of FIG. 3A to the registry. The registry then authenticates the resource request message as being issued by the grantee. The registry next searches for a received proxy that assigns an e-credential and a scope of grant to the grantee that will enable the request to be permitted by the repository. If no sufficient proxy is located by the registry, the resource request message is denied. If a relevant and authorizing proxy is located, the registry creates a resource request authorization message, as shown in FIG. 4, and transmits the resource request authorization message to the grantee.

The resource request authorization message includes the proxy, or a sufficient reference to the proxy or a sufficient portion of the proxy, the resource request and a data element that can be used to authenticate that the resource request authorization message has in fact been issued by the registry.

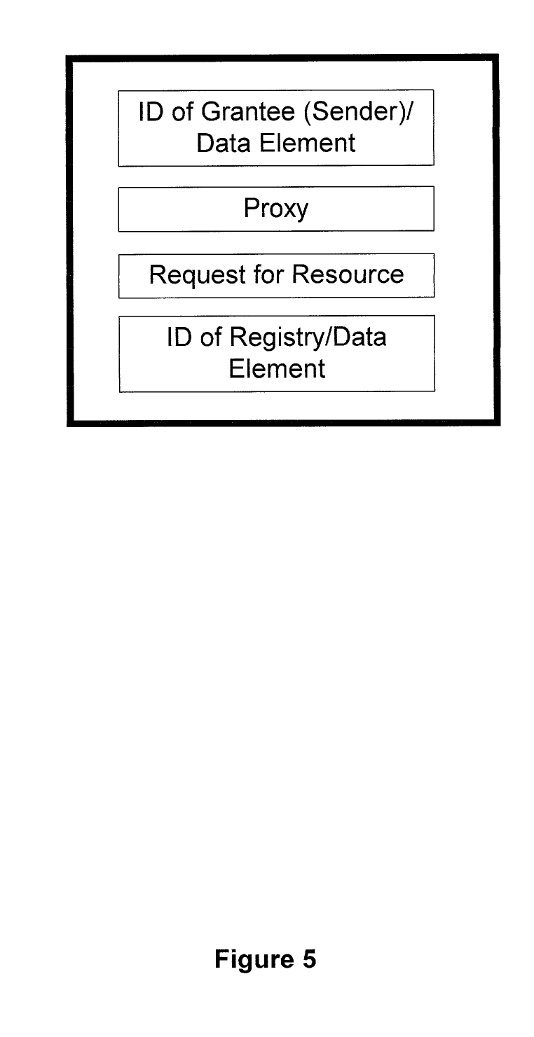

After receiving the resource request authorization from the registry, the grantee then bundles the resource request authorization message into a request with proxy message, as per FIG. 5. The request with proxy message includes the resource request authorization message, or a sufficient portion of the resource request authorization message, and a data element that can be used to authenticate that the request with proxy message has in fact been issued by the grantee. The grantee then transmits the request with proxy message to the repository.

After receiving the request with proxy message, the repository attempts to authenticate that the request with proxy was in fact transmitted by the grantee. In addition, the repository attempts to authenticate that the resource request authorization message contained within the request with proxy message was in fact issued by the registry. If either authentication fails, the resource request is denied. If both authentication requests are successful, the repository allows and/or enables the resource to process the request.

The First Preferred Embodiment is designed to support a convenient integration of the method of the present invention into a certain types of existing IT infrastructure. The process steps carried out by the registry reduce the burden placed upon either the grantee or the repository from the task of storing e-credentials and of analyzing proxy contents. The utility of the registry therefore includes a reduction in modification necessary to the grantor, the grantee and/or the repository in certain implementations of the method of the present invention within existing IT infrastructures.

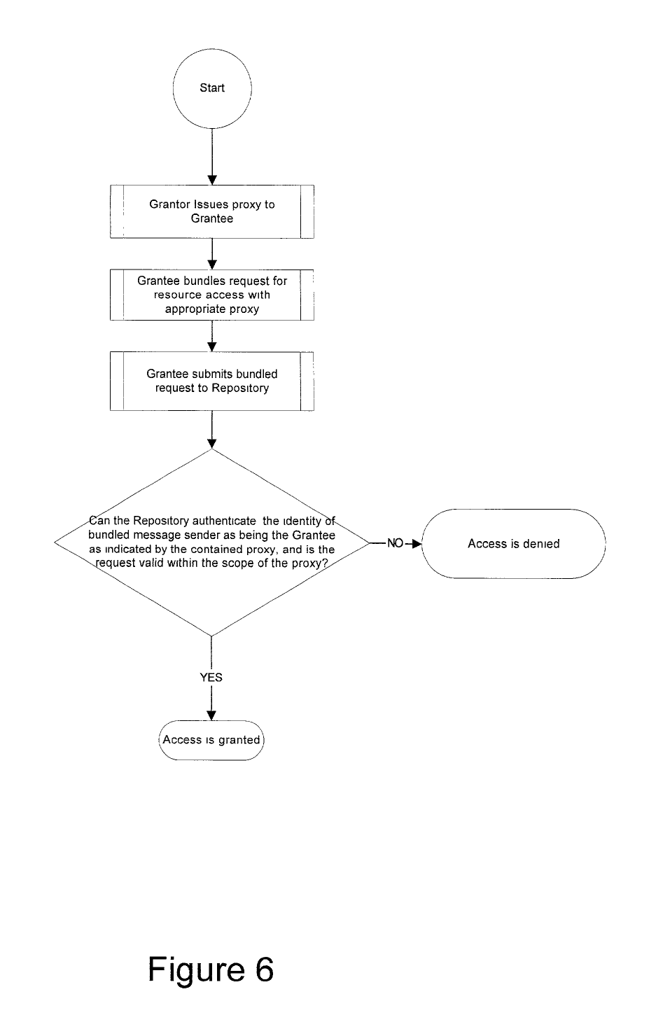

Referring now generally to the drawings, and particularly to FIGS. 1, 3 and 6, a Second Preferred Embodiment includes the creation of the proxy of FIG. 3 by the grantor. In this alternate preferred embodiment, the grantor transmits the proxy to the grantee. The grantee creates a resource request with proxy message by bundling the proxy, or a sufficient portion of the proxy, with a resource request and a data element that can be used to authenticate that the resource request with proxy message has in fact been issued by the grantee. The grantee then transmits the resource request with proxy message to the repository.

After receipt of the resource request with proxy message by the repository, the repository attempts to authenticate that the resource request with proxy message in fact was generated by the grantee. If this authentication fails the repository denies the resource request. Furthermore, before allowing a resource request to be processed, the repository will also attempt to authenticate that the grantor in fact issued the proxy. If either authentication fails, the repository will deny the resource request. If both authentications are successful, the repository will analyze the resource request and the proxy and will therefrom determine if the resource request is authorized by the proxy. If the resource is not authorized by the proxy, the repository will deny the resource request. If the resource request is authorized by the proxy, and the two authentications are successful, the repository will allow and/or enable the resource to process the grantee's resource request.

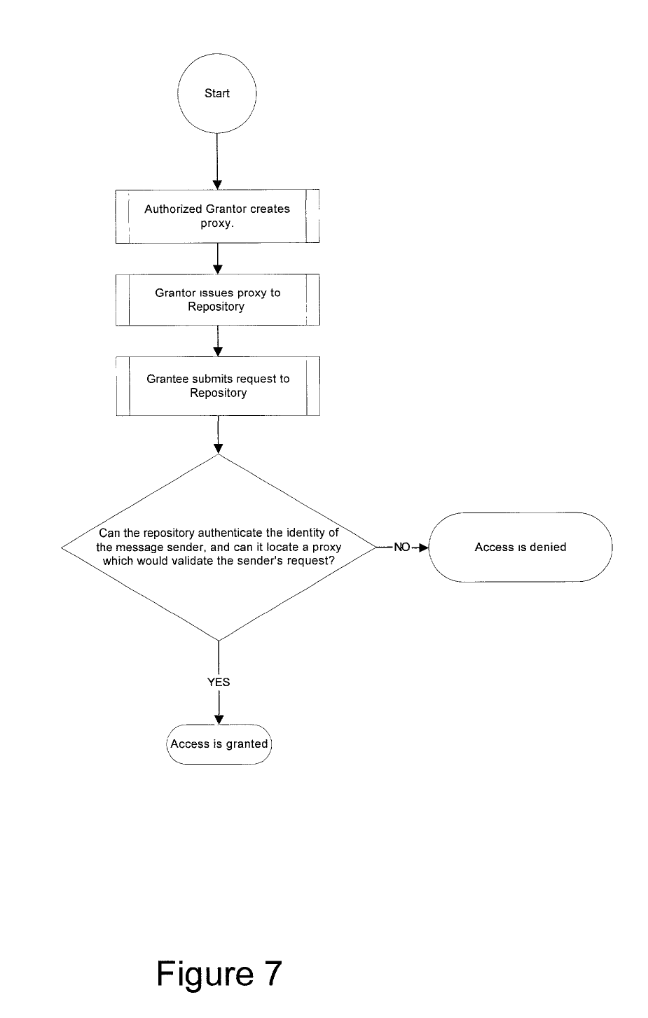

Referring now generally to the Figures and particularly to FIGS. 1, 3, 3A and 7, a Third Preferred Embodiment of Method of the present invention is described in the work process flow chart of FIG. 7. In the Third Preferred Embodiment, the grantee issues the proxy of FIG. 3 to the repository. When the grantee thereafter submits the resource request of FIG. 3A to the repository, the repository thereupon authenticates the resource request as being generated by the grantee. If this authentication fails, the resource request is denied. If this resource request is authenticated as being generated by the grantee, the repository must also compare the resource request against the proxy, or against a plurality or multiplicity of proxies, and therefrom determine if at least one proxy authorizes the resource request by the grantee. If the repository determines that the proxy in fact authorizes the resource request, and the authentication of the resource request as being generated by the grantee is successful, the repository will thereafter allow and/or enable the resource to process the request. If the proxy does not authorize the resource request, the repository will deny the resource request.

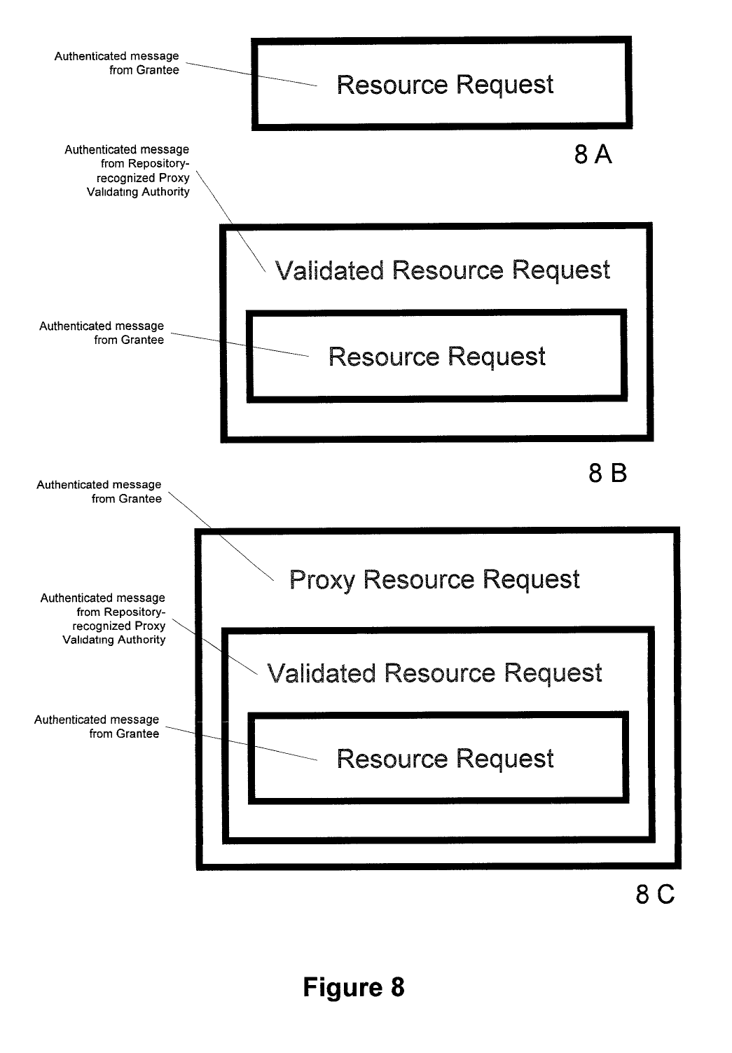

Referring now generally to the Figures, and particularly to FIGS. 8A, 8B and 8C, certain alternate preferred embodiments of the method of the present invention employ messages comprised the contents as represented in the FIGS. 8A, 8B and 8C. FIG. 8A illustrates an abstract of a resource request as issued by the grantee and as sent to the registry, where the registry is a proxy validating authority recognized by the repository.

FIG. 8B illustrates the abstract of a validated resource request as issued by the registry and transmitted to the grantee. The registry is performing as a recognized proxy validating authority in issuing the validated resource request of FIG. 8B. The validated resource request of FIG. 8B substantially contains the resource request of FIG. 8A. The validated resource request of FIG. 8B is authenticatable as originating from the registry.

The grantee then receives the validated resource request from the registry and generates a proxy resource request of FIG. 8C. The proxy request of FIG. 8C substantially comprises the validated resource request of FIG. 8B. The proxy resource request of FIG. 8B is authenticatable as originating from the grantee. The grantee then transmits the proxy resource request of FIG. 8C to the repository.

Upon receipt of the proxy resource request of FIG. 8C by the repository, the repository authenticates the identity of the grantee as the sender of the proxy resource request. The repository additionally authenticates the identity of the originator of the resource request as being the grantee. Furthermore, the repository authenticates that the resource request was in fact validated by the registry, where the registry has performed as a proxy validating authority recognized by the repository.

In certain still alternate preferred embodiments of the method of the present invention, the repository does not authenticate the identity of the originator of the message request per se, but more simply compares a uniquely identifying data element of the message request with the identity of the grantee. The repository is therein relying upon the validation and authentication performed by the registry as having properly previously authenticated and validated the resource request.

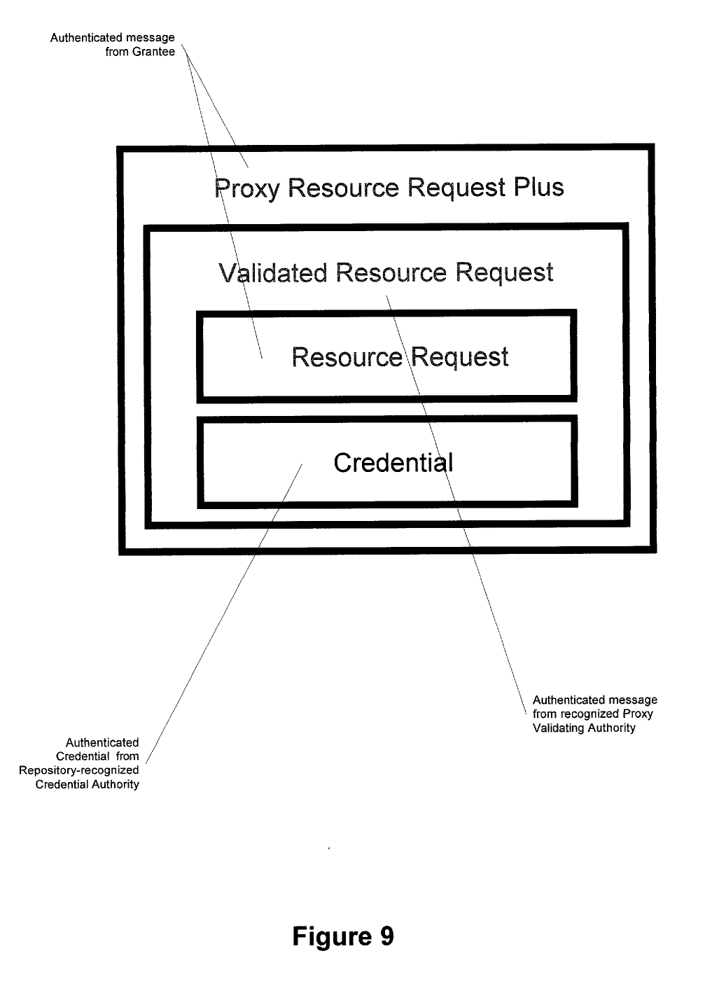

Referring now to generally to the Figures, and particularly to FIGS. 8C and 9, certain yet alternate preferred embodiments of the method of the present invention substantially include, as illustrated in FIG. 9, the credential used by the registry to validate the resource request of 8C. This additional component of the proxy resource request plus of FIG. 9 enables the repository, or another party, to confirm that the validation as previously performed by the registry was executed correctly.

The functions described herein of message and message sender validation, authorization, credentialization and authentication are performed by various parties in a numerous variety of alternate preferred embodiments of the method of the present invention.

Those skilled in the art will appreciate that various adaptations and modifications of the just-described preferred embodiments can be configured without departing from the scope and spirit of the invention. Digital signature authentication methods, and public key cryptography applications, and other suitable authentication techniques and methods can be applied in numerous specific modalities by one skilled in the art and in light of the description of the present invention described herein. Therefore, it is to be understood that the invention may be practiced other than as specifically described herein.

What is claimed is:

1. A method to delegate access and authorization control by a grantor to a grantee within an Information Technology System, the method comprising:
a) a creation of an electronic proxy document, or proxy, the proxy identifying the grantor, identifying the grantee, and specifying the scope of grant;
b) a submittal by the grantee of a request for access to a resource repository, where the request for access is authorized by the proxy;
c) validation by the resource repository of the request for access as authorized by the proxy; and
d) permitting access as requested by the request for access.

2. The method of claim 1, wherein the method further comprises an electronic signature of the proxy by the grantor.

3. The method of claim 1, wherein the method further comprises XML documents.

4. The method of claim 2, wherein the method further comprises the electronic signature comprises public key cryptography.

5. The method of claim 1, wherein the method further comprises electronic data interchange messages.

6. The method of claim 1, wherein the method further comprises formatted digital messages.

7. A method according to claim 1, wherein the method further comprises a validation of the proxy authorization of the request for access by means of a cryptographic authentication technique.

8. The method of claim 1, wherein the method further comprises a provision of the proxy to the resource repository.

9. The method of claim 8, wherein the method further comprises the provision of the proxy to the resource repository via a proxy registry.

10. The method of claim 1, wherein the method further comprises a revocation of a previously issued scope of grant by the proxy.
